(19) United States
(12) Patent Application Publication
(10) Pub. No.: US 2017/0065909 A1
(43) Pub. Date: Mar. 9, 2017

(54) DECANTER WASH NOZZLE FOR USE IN MAKING OIL COMPOSITIONS

(71) Applicant: POET Research, Inc., Sioux Falls, SD (US)

(72) Inventor: Steven G. Redford, Brandon, SD (US)

(21) Appl. No.: 15/163,898

(22) Filed: May 25, 2016

Related U.S. Application Data
(60) Provisional application No. 62/215,303, filed on Sep. 8, 2015.

(51) Int. Cl. B01D 21/26; A23K 10/30; C10L 1/02; A23D 9/04

(52) U.S. Cl. CPC B01D 21/26; A23D 9/04; A23K 10/30; C10L 1/02

(57) ABSTRACT

A scroll conveyor for making a liquid product including a bowl including an inner area, a first portion adjacent to a first end of the bowl, a second portion adjacent to the first portion, and a discharge end opposite the first end, and a scroll conveyor coaxially mounted within the bowl, the conveyor including a cylindrical body, a central opening extending through a length of the cylindrical body, a first end adjacent to the first end of the bowl, a second end spaced from the first end of the conveyor, a helical scroll flight extending from an outer surface of the cylindrical body, and at least one wash nozzle extending from the outer surface of the cylindrical body.

### CROSS-REFERENCE TO RELATED APPLICATIONS

This application claims the benefit under 35 U.S.C. §119(e) of U.S. Provisional Patent Application No. 62/215,303, filed Sep. 8, 2015, titled “DECANTER WASH NOZZLE FOR USE IN MAKING OIL COMPOSITIONS,” which is incorporated herein by reference in its entirety.

### TECHNICAL FIELD

The present invention is related to equipment used in the making oil compositions, such as in the context of ethanol manufacturing, and particularly relates to equipment used in the decanting step of such a manufacturing process.

### BACKGROUND

Ethanol can be produced from grain-based feedstocks (e.g., corn, sorghum/milo, barley, wheat, soybeans, etc.), from sugar (e.g., sugar cane, sugar beets, etc.), and/or other materials derived from plant sources. In addition to the manufacture of alcohol from carbohydrate materials of a feedstock, for example, a number of co-products can be generated that are additional sources of revenue for the manufacturer. These co-products include materials such as carbon dioxide gas for the industrial and food industries, protein rich animal feed products, and oils.

In a typical ethanol plant, corn, sugar cane, other grain, beets, and/or other plants are used as a feedstock, and ethanol is produced from starch contained within the corn or other plant feedstock. In the case of a corn facility, corn kernels can be used to prepare starch-containing material for processing. Initial treatment of the feedstock can vary by feedstock type. Generally, however, the starch and sugar contained in the plant material is extracted using a combination of mechanical and chemical means. For example, starch-containing material can be slurried with water and treated with heat to convert the starch into sugar (e.g., glucose). Many ethanol production facilities convert grain starch to sugar through a heat intensive jet-cooker step. After converting starch into sugar, the sugar can be fermented, where the sugar is converted by an ethanologen (e.g., yeast) into ethanol. The fermentation product is referred to as beer, which comprises a liquid component, including ethanol, water, and soluble components, and a solids component, including unfermented particulate matter and other products.

The fermentation product of a typical ethanol plant is sent to a distillation system for its distillation and dehydration into ethanol. The residual matter (e.g., whole stillage) can be dried into dried distillers grains (DDG) and sold, for example, as an animal feed product. Additionally, certain methods of removing oil found in the stillage after distillation are known in the art. However, when oil is removed from whole stillage after distillation, the content of free fatty acids tends to be higher than desired. The percentage of free fatty acids (%FFA) can be used as a primary indicator of oil quality since the %FFA is generally considered an indication of the amount of post-processing that may be required for final use of the oil (for biodiesel, for example). Free fatty acids can be produced as a result of heating the oil found in the grain feedstock. The heating involved in many ethanol processes (e.g., converting starch to sugar, distillation, and the like) can cause oil degradation. Another indication of oil degradation due to heating is the generation of ethanol esters.

With the advent of “cold cook” ethanol production, the use of enzymes can be employed instead of excessive heat in order to convert starch in grain material to sugar. The recovery of oil from such a cold cook processes are detailed, for two examples, in U.S. patent application Ser. No. 12/208,127 entitled “Oil Composition and Method of Recovering the Same” filed Sep. 10, 2008, and in PCT Publication No. WO 2013/126561 entitled “Oil Compositions and Methods of Production,” both of which are hereby incorporated by reference in their entireties. The resulting percentage of free fatty acids derived from this cold cook process is lower (e.g., less than 3-5%) than oils generated through a jet cooker ethanol facility. In order to increase the effectiveness of such processes, it is desirable to provide equipment and methods for improving the amount of oil that can be separated from the solids prior to distillation.

### SUMMARY

The present invention provides methods and equipment that can be used for making alcohol from plant material (e.g., grains such as corn kernels). According to the present invention, oil is separated from one or more alcohol production process streams at least prior to distillation. Advantageously, the oil can avoid undue exposure to elevated temperatures (e.g., typical distillation temperatures) and have relatively lower amounts of one or more free fatty acids and/or one or more alcohol esters such as ethanol esters as compared to oil produced from alcohol manufacturing and that is exposed to distillation temperature(s) in one or more distillation systems.

According to one aspect of the present invention, a method of making an oil product includes providing a decanter used in a distillation process in which a bowl and scroll conveyor are rotated at their respective operating speeds, which are at least slightly different from each other, while a feed liquid is fed into the system at a first end of the conveyor so that it enters the center area of its cylindrical portion and exits through a discharge port into the inner area of the bowl. Centrifugal action is caused by the rotation of the bowl, thereby moving the solid matter suspended in the feed liquid toward the inner surface of the bowl. At the same time, wash liquid is exiting one or more nozzles, which are provided on the scroll conveyor, toward the solid matter that is collecting adjacent to the inner surface of the bowl. Depending on the length of the nozzles relative to the amount of solid matter it encounters, the nozzles can come in physical contact with the solid matter at the same time that fluid is being directed toward that solid matter. In such a case, the nozzles will provide a dual function for breaking up the solid matter so that it can be washed by the wash fluid. Alternatively, the nozzles are shorter such that they do not contact the solid matter, although the wash liquid provided by the nozzles will wash the solid matter. Residual fluid from this process can exit the bowl through an aperture at the same time that the washed solids are moving toward the solid discharge end of the bowl.

In an exemplary embodiment, one or more of the nozzles provided on the scroll conveyor include a rake-type plate or paddle extension that can squeeze or smear the oil product toward the bowl during rotation of the scroll conveyor. In this way, the oil product can be forced below the plate and up through the rake elements at the end of the plate, thereby releasing additional oil that may be trapped in the solids. The plate may have a wide variety of configurations, such as flat, curved, or otherwise contoured to provide for certain movement of material relative to the bowl.

The present invention will be described in more detail below in the detailed description of the invention and in conjunction with the figures mentioned below.

### BRIEF DESCRIPTION OF THE DRAWINGS

The invention will be explained with reference to the appended Figures, wherein like structure is referred to by like numerals throughout the several views, and wherein:

FIG. 1 is a partial cross-sectional side view of an embodiment of a decanter of the present invention;

FIG. 2 is an enlarged side view of a portion of the inner area of the decanter of FIG. 1;

FIG. 3 is an enlarged perspective view of a portion of the inner area of the decanter of FIG. 1;

FIG. 4 is a top view of an exemplary nozzle for use with a decanter of the present invention, with inner features shown in dashed lines;

FIG. 5 is an exploded perspective view of the nozzle illustrated in FIG. 4;

FIG. 6 is a perspective view of a feed tube of the nozzle illustrated in FIGS. 4 and 5;

FIG. 7 is a cross-sectional side view of the feed tube of the nozzle of FIG. 6;

FIG. 8 is a front view of the directional sleeve of the nozzle illustrated in FIG. 5;

FIG. 9 is a perspective view of another exemplary nozzle for use with a decanter of the present invention;

FIG. 10 is another perspective view of the nozzle of FIG. 9, with portions shown as translucent to better view the inner components;

FIG. 11 is a side view of the nozzle illustrated in FIG. 9;

FIG. 12 is a front view of the nozzle illustrated in FIG. 9;

FIG. 13 is a perspective view of another exemplary nozzle for use with a decanter of the present invention; and

FIG. 14 is an exploded perspective view of a portion of the nozzle of FIG. 13.

### DETAILED DESCRIPTION

The present invention relates to compositions and methods of generating an oil product, including the efficient and effective separation of oil from solids. The oil product can be manufactured at a low energy ethanol production facility as a co-product to the fermentation of grain materials such as corn materials. With the equipment and methods of the invention, the oil product is subjected to relatively low temperatures as compared to other methods used in the industry.

The present invention relates to the manufacture and compositions of unique oil products through the production of alcohol (e.g., ethanol) from a feedstock such as corn grain material. The oil products (e.g., corn oil product) have one or more applications such as an animal feed supplement, industrial uses, biodiesel production, and human grade edible oil. Oil generated through ethanol production in this manner is unique as compared to traditional oils generated by ethanol producers due to the relatively low processing temperature and removal prior to distillation. This process protocol can help prevent substantial formation of free fatty acids, which are often indicative of reduced oil quality.

While reference is made herein to the use of corn kernels as the starting feedstock for providing a plant material, one or more other plant materials may be used alone or in combination in other processes. For example, soybean, or a combination of grains, may be utilized in some cases to generate alcohol such as ethanol and co-products. Accordingly, any of the disclosed ethanol production facilities may include modifications for the processing of other feedstock instead, or in addition to, corn kernels. For example, soybean has a very large oil concentration and is well suited for the production of oil.

In an exemplary biorefinery, an ethanol production facility is configured to produce ethanol from corn, for example. Such a biorefinery includes an area where corn (or other suitable material including, but not limited to, biomass, sugars, and other starch products) is delivered and prepared to be supplied to the ethanol production facility. The ethanol production facility comprises apparatus for preparation and treatment (e.g., milling or fractionating) of the corn into corn flour suitable for fermentation into fermentation product in a fermentation system. The ethanol production facility also includes a distillation system in which the fermentation product can be distilled and dehydrated into ethanol. The biorefinery may also include a by-product treatment system such as a centrifuge, a dryer, and/or an evaporator.

The biorefinery may be a fractionation style biorefinery. However, it is considered within the scope of the present disclosure that whole kernel biorefinery plants may also be employed for the generation of oil products, as will be described in further detail below. In some embodiments, the biorefinery may be referred to as a “fractionation” ethanol production facility, where the corn kernel is fractionated into its three component parts prior to milling. These include the outer shell (corn bran), which is predominantly a fiber material and part of the fiber component, the starch filled endosperm component, and a protein rich germ component. In some embodiments, only the endosperm component is further processed for fermentation into ethanol. In other embodiments, both the endosperm component and the germ component are further processed for fermentation into ethanol.

One benefit of fractionation is that one or more low starch components can be syphoned into different process streams, thereby providing at least the high-starch endosperm to liquefaction, fermentation and distillation. This helps provide an operation that may be more efficient while lowering yeast and enzyme requirements and lowering the amount of energy expended per gallon of ethanol produced. In some embodiments, one or more of the other components such as corn bran and germ fractions may be sold as additional co-products for the feed industry, or may be further processed to generate higher value co-products. The whole corn kernel can be milled and provided to the fermentation system. One benefit of milling the entire corn kernel instead of fractionating is that the germ component includes starch and oil and the endosperm component includes starch and oil such that the overall ethanol production can be increased due to the higher level of starch and such that the overall oil production can be increased due to the higher level of oil.

In an ethanol production process that uses cold-cook ethanol production processes, corn or other suitable feed material may be prepared for further treatment in a preparation system. The preparation system may include an optional fractionation system to fractionate the corn kernel into its three constituents, as described above. Fractionation may employ mills, size exclusion and density separation in order to be effectual. The bran and germ components can be removed for further processing or sale as raw materials. In some cases, a screening process may be performed prior or post fractionation that removes foreign material, such as rocks, dirt, sand, pieces of corn cobs and stalk, and other unfermentable material. After fractionation, the particle size of the endosperm may be reduced by milling to facilitate further processing. In processes where fractionation is omitted, the whole corn kernel may alternatively be milled to whole corn flour.

In an embodiment of a process, at least a portion of the one or more oligosaccharides and/or one or more polysaccharides are converted into one or more monosaccharides in a first treatment system. For example, milled corn can be slurried with water, enzymes and agents to liquefy the starch containing material and facilitate the conversion of starch into sugar (e.g. glucose). In many “conventional” corn-to-ethanol facilities, the flour slurry is heated in a jet cooker in order to convert the starch into sugar. However, by using an enzymatic approach, without any external heating to convert starch to sugar, a “cold cook” process is achieved. A cold cook conversion to monosaccharides can occur at a temperature less than 180° F., or less than 150° F., or even less than 120° F. Such a cold cooking process generally requires less energy, results in overall decreased costs, and minimizes heat damage to the starch and proteins of the corn flour. Likewise, less heat damage occurs to the fats of the corn, thereby reducing the generation of free fatty acids and ethanol esters.

Next, the treated plant material can be delivered from the treatment system to the fermentation system, where at least a portion of the one or more monosaccharides can be fermented to form a fermentation product that includes at least the oil from the plant material and a biochemical. Such biochemicals that are formed by fermenting monosaccharides are well known and include, for example, ethanol, butanol, and the like. For example, the sugar slurry from treatment system can be converted into ethanol by an ethanologen in fermentation system. The fermentation product is a slurry referred to as “beer,” which typically includes a liquid component, including ethanol, oil, water and soluble components, and a solids component, including unfermented particulate matter (among other things). Optionally, the fermentation product may be treated with agents in a second treatment system. At this stage, a low energy facility differs from a standard cold cook facility.

A conventional ethanol process provides the entire treated fermentation product, which consists of a solid component and a liquid component, directly to a distillation system. In the distillation system, the (treated) fermentation product is distilled and dehydrated into ethanol. Optionally, in some embodiments, the removed components (e.g., whole stillage), which comprise water, soluble components, oil and unfermented solids (e.g., the solids component of the beer with substantially all ethanol removed), may be subjected to further processing in an oil separation system to yield oil. This oil being generated from a cold cook process has less heat damage (and subsequently lower free fatty acids) than oil from a jet cooker facility. However, despite these improvements, the oil has been subjected to some heat damage in the distillation system. The solids of the whole stillage may be dried into dried distillers grains (DDG) in a third treatment system, where the removed components may be treated with agents and sold as an animal feed product. Other co-products, such as syrup, may also be recovered from the stillage.

According to the present invention, at least a portion of the oil is separated from the fermentation product prior to distillation so as avoid undue exposure to distillation temperatures in the distillation system. The initial stages of such a manufacturing process are similar to known cold cook plants discussed above, wherein whole corn is delivered to a preparation system and can be milled to generate flour or, alternatively, the corn can be fractionated using an optional fractionation system. Corn bran (fiber) and germ components can be removed, and the endosperm can be sent to the milling system for size reduction to flour. Alternatively, only the fiber is removed and the germ component and the endosperm component can be sent to the milling system for size reduction to flour.

The corn material (including starch) can be slurried in a treatment system with water and enzymes, and one or more agents can optionally be used to yield treated components that include sugars. Yeast and other agents can be added to a fermentation system in order to convert the sugars to alcohol, such as ethanol, and carbon dioxide. After fermentation, the exemplary processes of the invention differ from the ethanol production practices described above in that the resulting fermentation beer is sent to an oil extraction system prior to any distillation so that an oil product can be extracted and not exposed to distillation temperatures. The oil extraction system includes first providing beer to a solids separator for removal of the solids from the beer. This solids removal step may include the use of a decanter of the type that is described below in accordance with the invention, wherein such a decanter includes features that provide for effective oil extraction by “washing” oil from the solids.

After the solids are removed from the beer by the decanter, the liquids can be concentrated in a concentrator, and the oil can be separated out of the concentrate using an oil separator. For example, the liquid may be subjected to pressure against a membrane with pores that enables the ethanol, water and fines to pass through the membrane, while retaining larger oil or oil emulsion fraction (also referred to as a “concentrate”). The de-oiled liquids can be provided to a distillation system for the distillation of ethanol. Finally, the oil can be separated from the concentrate via a separator which can generate a clean oil product.

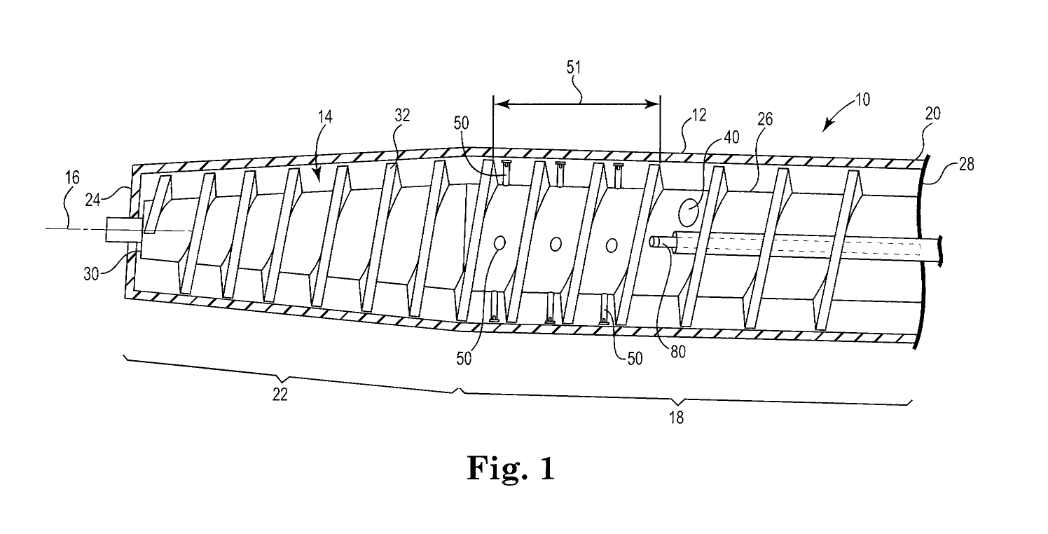

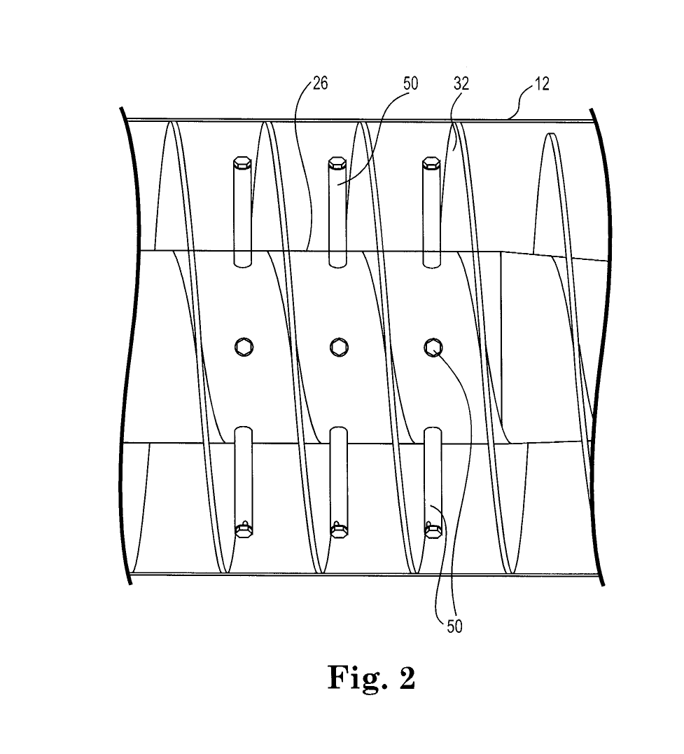

Referring now to the Figures, wherein the components are labeled with like numerals throughout the several Figures, and initially to FIGS. 1-3, a portion of a decanter 10 is illustrated, which may be referred to as a solid bowl decanter. Decanter 10 is of the type that can be considered to be a scroll discharge type of decanter, and generally includes a solid bowl 12 that rotates at a first speed and a scroll conveyor 14 positioned in the bowl that rotates at a different speed from the bowl. With such a decanter 10, separated solids are conveyed to a solids discharge at one end of the bowl 12, while the remaining fluid exits the decanter at from a different end of the bowl 12.

In more particularity, decanter 10 includes a solid bowl 12 that rotates about a horizontal axis 16 by a first motor or other drive member (not shown). The scroll conveyor 14 is coaxially mounted within the bowl 12 and is driven for rotation at a slightly different speed from the speed at which the bowl 12 rotates. The bowl 12 includes a first or cylindrical portion 18 adjacent a first end 20 of the bowl 12 and a second or tapered portion 22 extending from the first portion 18 at a second or solid discharge end 24 of the bowl 12. The scroll conveyor 14 is independently rotatable within the bowl 12 via a drive means (not shown), and includes a central cylindrical portion 26 with a central opening extending along its length. The scroll conveyor 14 further includes a first end 28 that is adjacent to the first end 20 of the bowl 12, and a second end 30 spaced from the first end 28. It is noted that this first end 28 is a representative location, as it is understood that the actual first end of the scroll conveyor 14 can extend further beyond the bowl 12 than is illustrated in the drawing.

Scroll conveyor 14 further includes a helical scroll flight 32 extending from the outer surface of the cylindrical portion 26. The tips of the helical scroll flight 32 are located so that they are close to the inner surface of the bowl 12 but spaced at least slightly from that inner surface. In this way, when the bowl 12 and the scroll conveyor 14 are rotated at their respective operating speeds (with at least a small difference in speed from each other), solids will be moved outwardly and toward the inner surface of the bowl 12 by centrifugal action, and also scrolled or moved along the length of the bowl 12 toward its second or solid discharge end 24. The remaining or separated liquid will be discharged via a discharge port adjacent the opposite end of the bowl 12.

The fluid to be separated, which can also be referred to as “feed liquid”, is introduced into the decanter 10 at the first end 20 through a feed mechanism, such as a pipe, which can be coaxially mounted within the cylindrical portion 26 of the scroll conveyor 14. The feed liquid is moved along a portion of the length of the scroll conveyor 14 until it reaches a discharge port 40 of the wall of the cylindrical portion 26. The feed liquid then exits the cylindrical portion 26 and enters the space between the extensions of the scroll flight 32 and the inner surface of the bowl 12.

Further in accordance with the invention, the scroll conveyor 14 includes a wash zone 51 including at least one wash nozzle 50 extending from an outer surface of the cylindrical portion 26. In an embodiment of the invention, a plurality of such nozzles 50 is provided, wherein the number of nozzles provided can depend on the additional washing capabilities that are desired for the process. In general, these nozzles 50 are designed to improve the displacement of solids that tend to gather at the inner surface of the bowl 12 during the separation process. This can be accomplished by the addition of a wash fluid to the system and/or by physical contact between the solid matter and the nozzles.

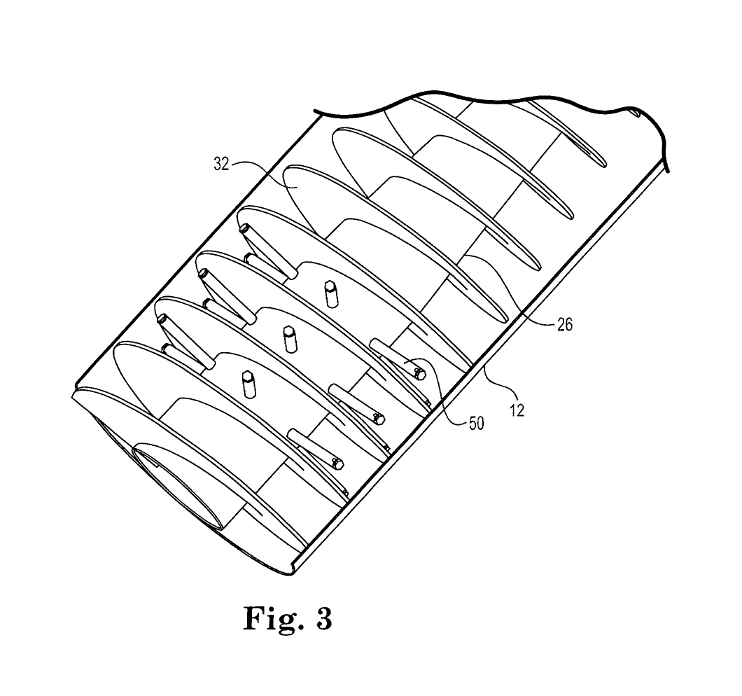

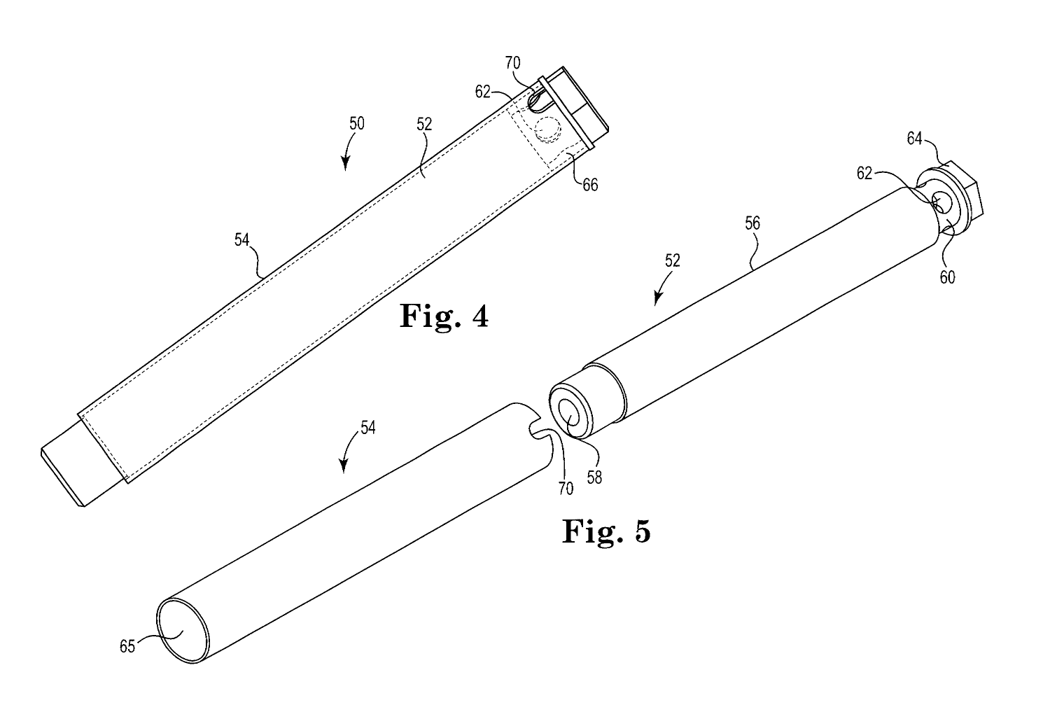

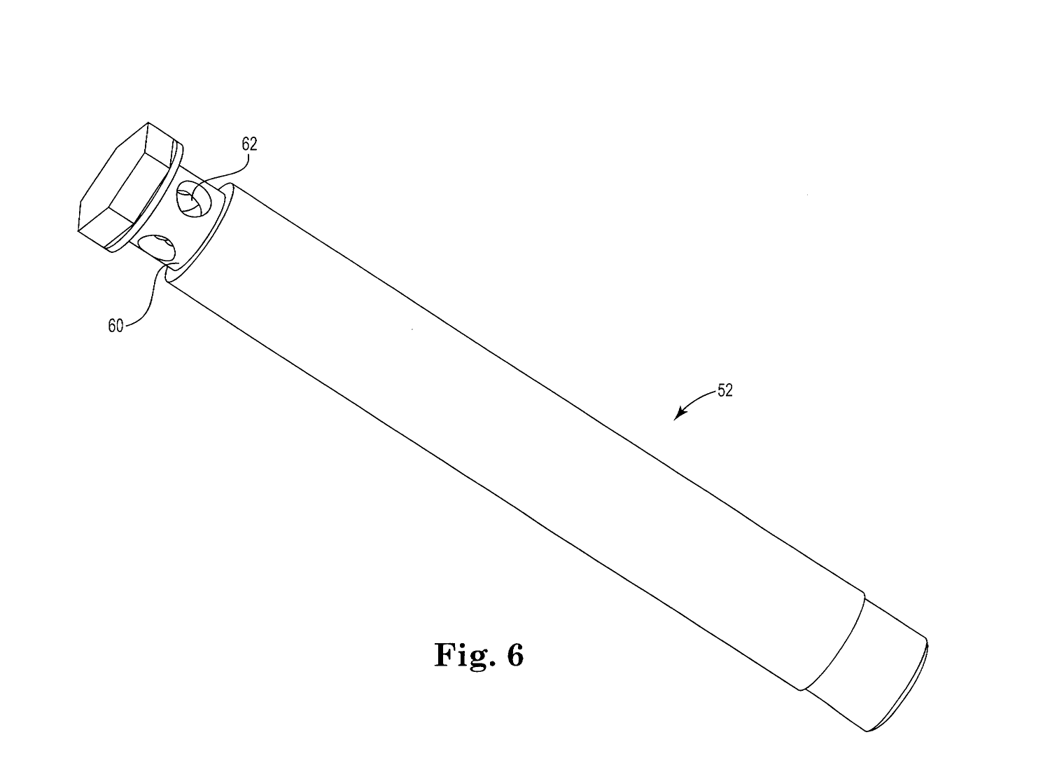

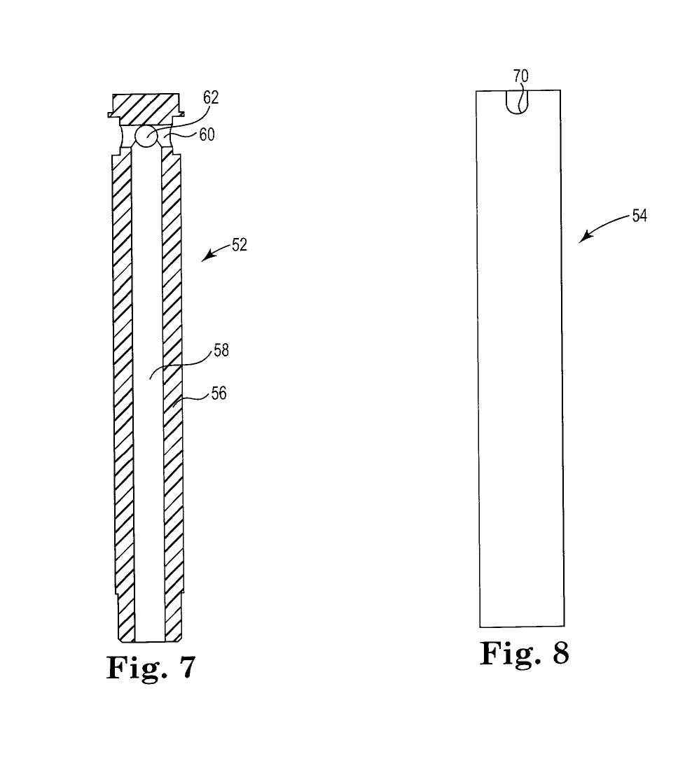

Referring now to FIGS. 4-8, one embodiment of a nozzle 50 of the invention is illustrated, which includes an inner feed tube 52 that is positionable within a directional outer sleeve 54. In particular, feed tube 52 includes a first cylindrical portion 56 with a central opening 58. A second portion 60 of feed tube 52 extends from one end of the first portion 56 and has a diameter that is at least slightly smaller than that of the first portion 56. The second portion 60 includes at least one aperture 62 that is in fluid communication with the central opening 58. The feed tube 52 may include one or multiple apertures 62 spaced from each other around the diameter of second portion 60. The feed tube 52 further includes a distal end 64 that is engageable with a tool during attachment of the nozzle 50 to the scroll conveyor 14, and therefore may include flat portions that are engageable with a tool having corresponding mating features.

Directional outer sleeve 54 includes a central opening 65 that is at least slightly larger than the outer diameter of the first cylindrical portion 56 of the feed tube 52. Because the diameter of the second portion 60 of the feed tube 52 is smaller than that of the first portion 56, a gap or channel 66 (best illustrated in FIG. 4) will be located between the outer surface of the second portion 60 of the feed tube 52 and the inner surface of the directional outer sleeve 54. In this way, fluid exiting the apertures 62 of the feed tube 52 will fill the channel 66, and will only be able to be discharged from the nozzle via at least one notch 70 provided at an end of the sleeve 54. The notch 70 is illustrated as u-shaped; however, any shape can be used, such as square, rectangular, oval, or the like.

It is further contemplated that any or all of the outer sleeves 54 provided for a particular decanter can include one notch 70 (as illustrated in the Figures) or more than one notch 70, wherein the multiple notches 70 can be spaced from each other around the periphery of the sleeve 54. Each of the notches can have the same or a different size, shape, and/or orientation as compared to other notches of the same sleeve 54. It is further contemplated that if an outer sleeve includes multiple notches 70, one or more of the notches can be blocked in such a way that fluid is directed to the one or more notches that are not blocked.

It is further contemplated that the shape of the nozzles can vary from the cylindrical shape described above and illustrated in the figures. For example, the cross section of one or more of the nozzles can be oval, elliptical, square, irregular, flat, or the like, wherein the shape can be the same along the entire length of the nozzle or can vary along the length of the nozzle.

Although only a single nozzle 50 can be provided for a particular embodiment of a scroll conveyor 14, multiple nozzles 50 can be positioned around the periphery of the central cylindrical portion 26 between the rotations of the helical scroll flight 32 to provide for a variety of washing capabilities. For one example, six nozzles 50 are spaced from each other around the periphery of a cylindrical portion as a single row of nozzles 50, although it is possible that more than one row of nozzles 50 is provided, such as the three rows of nozzles 50 illustrated in FIGS. 1-3. When multiple nozzles are provided, each nozzle can have a different size, shape, and/or orientation than other nozzles of the same scroll conveyor. For example, certain nozzles can be long enough that they contact the solid material while other nozzles are shorter so that they do not contact solid material. Also, the positioning of each of the nozzles relative to their respective fluid streams can be individually selected depending on the desired washing action. In an embodiment of the invention, the discharge of the nozzles is pointed in the opposite direction from the rotation of the scroll conveyor to minimize or prevent solids located in the bowl from entering the nozzle as those solids are being flushed or washed from the sides of the bowl.

Each of the nozzles 50 will be attached to the scroll conveyor 14 in a preselected location at apertures in the cylindrical portion 26. After they are installed, the nozzles will be in fluid communication with a wash water feed tube 80 (see FIG. 1) or other component that is positioned within the scroll conveyor 14. The orientation of each of the nozzles 50 can be selected during installation thereof, where the angle at which fluid will leave each nozzle through the one or more notches 70 is selected to provide for desired washing action of the exiting fluid.

In operation, the bowl 12 and scroll conveyor 14 are rotated at their respective operating speeds while a feed liquid is fed into the system at the first end 28 of the conveyor 14 so that it enters the center area of the cylindrical portion 26 and exits through discharge port 40 into the inner area of the bowl 12. Centrifugal action is caused by the rotation of the bowl 12, thereby moving the solid matter suspended in the feed liquid toward the inner surface of the bowl 12. At the same time, wash liquid is exiting the nozzles 50 toward the solid matter that is collecting adjacent to the inner surface of the bowl 12. Depending on the length of the nozzles relative to the amount of solid matter it encounters, the nozzles 50 can also provide a “raking” function in that they can come in physical contact with the solid matter at the same time that fluid is being directed toward that solid matter. In such a case, the nozzles 50 will provide a dual function for breaking up the solid matter so that it can be washed by the wash fluid. Residual fluid from this process can exit the bowl through an aperture at the same time that the washed solids are moving toward the solid discharge end of the bowl 12.

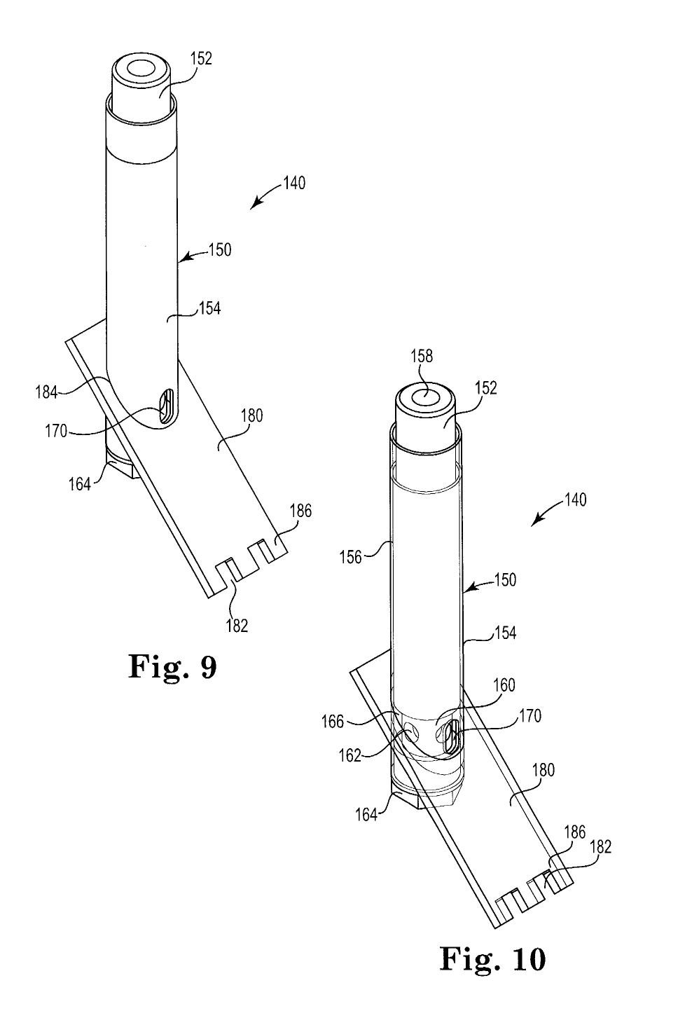

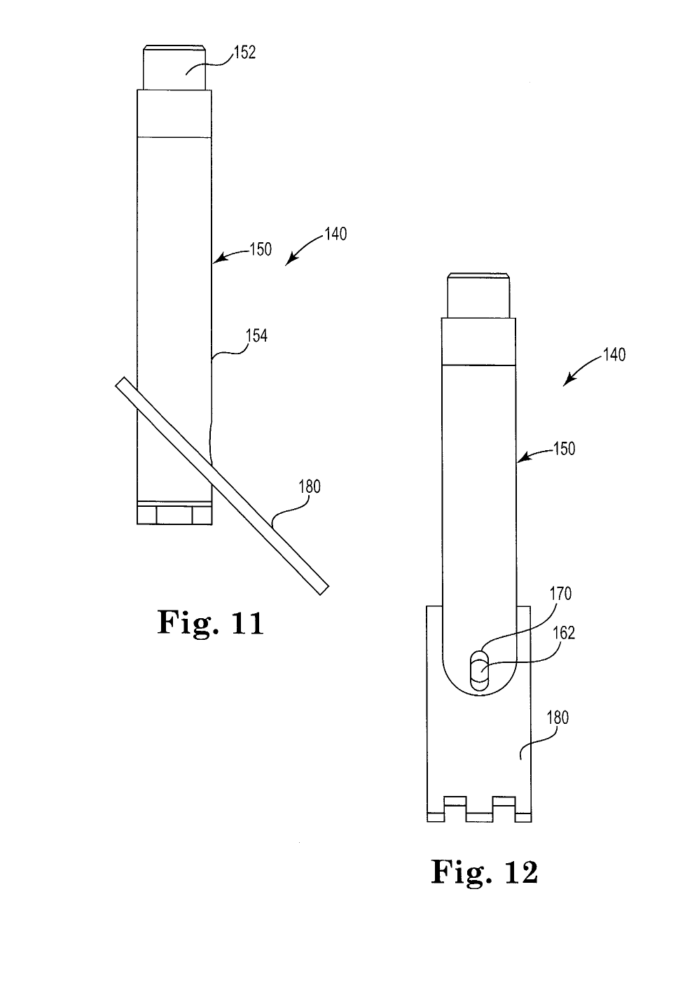

FIGS. 9-12 illustrate another exemplary embodiment of a nozzle assembly 140 of the invention, which is another configuration of structure that provides for the raking function mentioned above. Such a nozzle assembly 140 can be attached to a corresponding scroll conveyor in a similar manner as that discussed above relative to nozzles 50, wherein it is understood that a scroll conveyor can include one or more wash assemblies 140 in addition to or in place of nozzles 50, as desired. That is, a scroll conveyor can either include only nozzles 50, only nozzle assemblies 140, or a combination of these components. Further, in cases where the nozzles/nozzle assemblies are removable and replaceable from the scroll conveyor, an operator can choose the appropriate nozzles for a particular manufacturing operation, and then change them for future operations that have different processing requirements, if desired.

As will be described in detail below, nozzle assembly 140 includes a rake-type plate or extension from a tube assembly. This plate or extension can create a compression zone between the nozzles and the bowl to thereby squeeze or smear the oil product toward the bowl during rotation of the scroll conveyor. In this way, the oil product can be forced below the plate and up through the rake elements at the end of the plate, thereby releasing additional oil that may be trapped in the solids. The plate may have a wide variety of configurations, such as flat, curved, or otherwise contoured to provide for certain movement of material relative to the bowl. The plate can also be positioned at different angles of reproach to the bowl to provide different compression zones.

Nozzle assembly 140 includes a nozzle 150, which includes an inner feed tube 152 that is positionable within a directional outer sleeve 154. In particular, inner tube 152 includes a first cylindrical portion 156 with a central opening 158. A second portion 160 of inner tube 152 extends from one end of the first portion 156 and has a diameter that is at least slightly smaller than that of the first portion 156. The second portion 160 includes at least one aperture 162 that is in fluid communication with the central opening 158. The feed tube 152 may include one or multiple apertures 162 spaced from each other around the diameter of second portion 160. The inner tube 152 further includes a distal end 164 that is engageable with a tool during attachment of the nozzle 150 to a scroll conveyor, and therefore may optionally include flat portions or another feature or structure that is engageable with a tool having corresponding mating features.

Directional outer sleeve 154 includes a central opening that is at least slightly larger than the outer diameter of the first cylindrical portion 156 of the inner tube 152. Because the diameter of the second portion 160 of the inner tube 152 is smaller than that of the first portion 156, a gap or channel 166 (best illustrated in FIG. 10) will be located between the outer surface of the second portion 160 of the inner tube 152 and the inner surface of the directional outer sleeve 154. In this way, fluid exiting the apertures 162 of the feed tube 152 will fill the channel 166, and will only be able to be discharged from the nozzle via at least one aperture 170 that is provided near the end of the sleeve 154 so that it can be aligned with the aperture 162 of the inner tube 152. The aperture 170 is illustrated as having a racetrack type of shape; however, any desired shape can be used, such as square, rectangular, oval, or the like.

It is further contemplated that any or all of the outer sleeves 154 provided for a particular decanter can include one aperture 170 (as illustrated in the Figures) or more than one aperture 170, wherein the multiple apertures 170 can be spaced from each other around the periphery of the sleeve 154. Each of the apertures can have the same or a different size, shape, and/or orientation as compared to other apertures of the same sleeve 154. It is further contemplated that if an outer sleeve includes multiple apertures 170, one or more of the apertures can be blocked in such a way that fluid is directed to the one or more apertures that are not blocked.

It is further contemplated that the shape of the nozzles 150 can vary from the cylindrical shape described above and illustrated in the figures. For example, the cross section of one or more of the nozzles can be oval, elliptical, square, irregular, flat, or the like, wherein the shape can be the same along the entire length of the nozzle or can vary along the length of the nozzle.

Nozzle assembly 140 further includes a plate 180 that extends at an angle from the outer surface of the outer sleeve 154 of the nozzle 150 and has a rake or notch feature at one end. As shown, plate 180 is generally rectangular in shape, with an aperture 184 that is at least slightly larger than the outer surface of the outer sleeve 154 so that the outer sleeve 154 can be positioned within the aperture 184. Plate 180 further includes multiple gaps or notches 182 at its distal end, which define multiple rake portions 186 that provide for the “raking” function discussed above. Although plate 180 is illustrated as having two gaps or notches 182 that are the same size as each other, the plate 180 may instead include more or less than two gaps or notches spaced across the distal end of the plate 180. The plate 180 may also include gaps or notches having the same or different widths, depths, and or heights as compared to other gaps or notches of the same plate, depending on the raking performance desired for the operation. It is further contemplated that the plate 180 can itself be structured so that the ends of each of the rake portions 186 are along the same plane, or the ends of the rake portions 186 can be staggered across the width of the plate 180. Alternatively, the distal end of the plate 180 may include a contoured surface that includes one or more contours, curves, angles, and the like, rather than the illustrated notches. Plate 180 can be secured to the nozzle 150 in a number of ways, such as welding the plate 180 to the outer sleeve 154, for example.

As is described above relative to nozzles 50, although only a single nozzle assembly 140 can be provided for a particular embodiment of a scroll conveyor, multiple nozzle assemblies 140 can be positioned around the periphery of a central cylindrical portion between the rotations of a helical scroll flight to provide for a variety of washing capabilities. When multiple nozzle assemblies 140 are provided, each nozzle assembly 140 can have a different size, shape, and/or orientation than other nozzle assemblies of the same scroll conveyor. For example, certain nozzle assemblies can be long enough that a portion of the assembly (e.g., a plate 180) contacts the solid material, while other nozzle assemblies are shorter so that they do not contact solid material. Also, the positioning of each of the nozzle assemblies relative to their respective fluid streams can be individually selected depending on the desired washing action. In an embodiment of the invention, the discharge of the nozzle assemblies is pointed in the opposite direction from the rotation of the scroll conveyor to minimize or prevent solids located in the bowl from entering the nozzle as those solids are being flushed or washed from the sides of the bowl.

Each of the nozzle assemblies 140 will be attached to a scroll conveyor in a preselected location at apertures in the cylindrical portion. After they are installed, the nozzle assemblies will be in fluid communication with a wash water feed tube that is positioned within the scroll conveyor. The orientation of each of the nozzle assemblies 140 can be selected during installation thereof, where the angle at which fluid will leave each nozzle through the one or more apertures 170 is selected to provide for desired washing action of the exiting fluid.

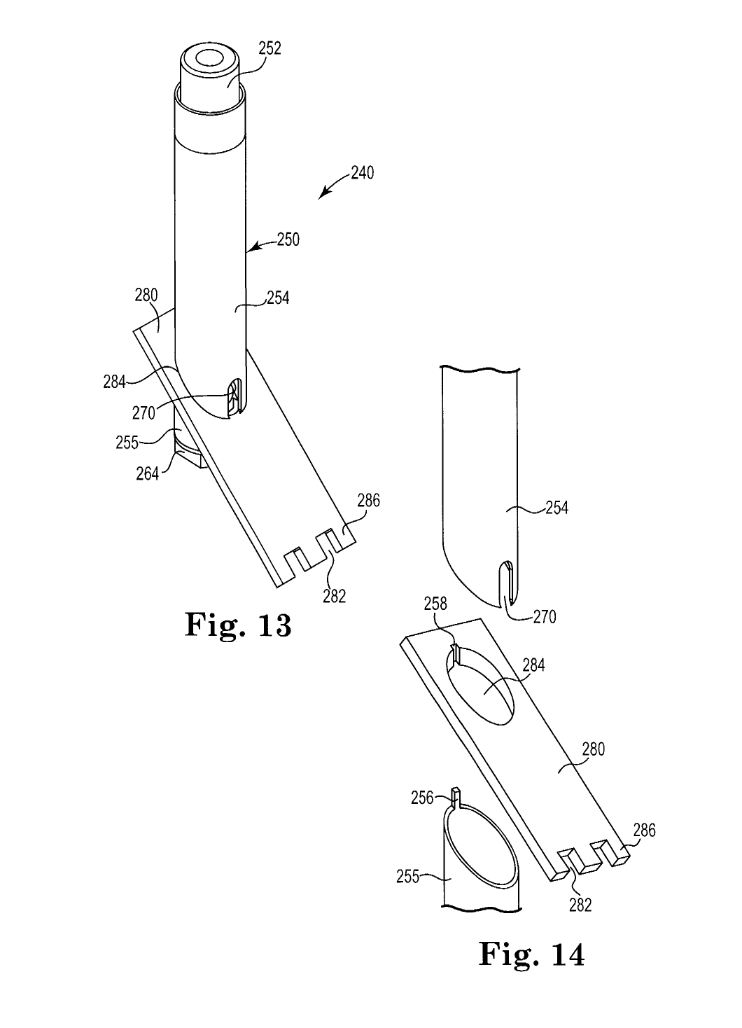

Another embodiment of a nozzle assembly 240 is illustrated in FIGS. 13 and 14, which assembly also includes a rake-type plate or extension from a tube assembly. Again, the plate may have a wide variety of configurations, such as flat, curved, or otherwise contoured to provide for certain movement of material relative to the bowl. The plate can also be positioned at different angles of reproach to the bowl to provide different compression zones.

Nozzle assembly 240 includes a nozzle 250, which includes an inner feed tube 252 that is positionable within a first portion 254 of a directional outer sleeve and a second portion 255 of a directional outer sleeve. The feed tube 252 may include one or multiple apertures (not shown) spaced from each other around the diameter of an end of the inner feed tube 252. The feed tube 252 further includes a distal end 264 that is engageable with a tool during attachment of the nozzle 250 to a scroll conveyor, and therefore may optionally include a feature or structure that is engageable with a tool having corresponding mating features.

First portion 254 and second portion 255 of the directional outer sleeve include a central opening that is at least slightly larger than the outer diameter of the feed tube 252. As with the embodiment described above relative to FIGS. 9-12, a gap or channel (not visible in these figures) will be located between the outer surface of the feed tube 252 and the inner surface of the directional outer sleeve 254. In this way, fluid exiting apertures of the feed tube 252 will fill the channel, and will only be able to be discharged from the nozzle via at least one aperture or notch 270 that is provided near the end of the sleeve 254 so that it can be aligned with an aperture of the inner feed tube 252. The aperture or notch 270 is illustrated as being a portion of a racetrack type of shape; however, any desired shape can be used, such as square, rectangular, oval, or the like.

It is further contemplated that any or all of the outer sleeves provided for a particular decanter can include one aperture or notch 270 (as illustrated in the Figures) or more than one aperture or notch 270, wherein the multiple apertures 270 can be spaced from each other around the periphery of the first portion 254 of the directional outer sleeve. Each of the apertures can have the same or a different size, shape, and/or orientation as compared to other apertures of the same sleeve. It is further contemplated that if an outer sleeve includes multiple apertures 270, one or more of the apertures can be blocked in such a way that fluid cannot exit certain aperture(s), thereby directing the fluid to the one or more apertures that are not blocked.

Nozzle assembly 240 further includes a plate 280 that extends at an angle from a distal end of the first portion 254 (i.e., between a distal end of the first portion 254 and a proximal end of the second portion 255), wherein the plate 280 has a rake feature at one end. As shown, plate 280 is generally rectangular in shape, with an aperture 284 that is at least slightly larger than the outer surface of the outer sleeve. Plate 280 includes multiple gaps or notches 282 at its distal end, which define multiple rake portions 286 that provide for the “raking” function discussed above. Aperture 284 includes a keyway or slot 258 that is engageable with a key 256 that extends from one end of the second portion 255 of the outer sleeve (although it is contemplated that one or more of such keys could instead be provided on the first portion 254 with a keyway or slot provided on the second portion 255). The key 256 can slide into the keyway 258 to secure the sections of the assembly to each other in such a way that the plate 280 cannot rotate relative to the outer sleeve. The illustrated key and slot are intended to be one exemplary embodiment of such a configuration, and it is contemplated that such an engagement between components could have a wide variety of different structures that provide for such a function.

The present invention has now been described with reference to several embodiments thereof The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but is further intended to encompass equivalents of those structures.

What is claimed is:

1. A method of making a liquid product comprising the steps of:
activating a decanter comprising a bowl rotating at a first operating speed coaxially mounted relative to a scroll conveyor rotating at a second operating speed that is different from the first operating speed, wherein:
the bowl comprises an inner area, a first portion adjacent to a first end of the bowl, a second portion adjacent to the first portion, and a discharge end opposite the first end; and
the scroll conveyor comprises a cylindrical body, a central opening extending through a length of the cylindrical body, a first end adjacent to the first end of the bowl, a second end spaced from the first end of the conveyor, a helical scroll flight extending from an outer surface of the cylindrical body, and at least one wash nozzle extending from the outer surface of the cylindrical body;
supplying a feed liquid into the central opening at the first end of the conveyor so that it exits the conveyor through an aperture of the cylindrical body into the inner area of the bowl;
providing wash liquid to the at least one wash nozzle so that the wash liquid enters a proximal end of the nozzle and exits a distal end of the nozzle positioned within the inner area of the bowl; and
discharging solids that separate from the feed liquid from the discharge end of the bowl.

2. The method of claim 1, wherein the first portion of the bowl is cylindrical and the second portion of the bowl is tapered from the first portion of the bowl toward the second end of the bowl.

3. The method of claim 1, wherein the at least one wash nozzle comprises a first nozzle having a length that provides for a space between the distal end of the first nozzle and an inner surface of the bowl.

4. The method of claim 1, further including the step of discharging wash fluid and residual fluid of the feed liquid from a different location of the bowl than the discharge end of the bowl.

5. The method of claim 1, wherein rotation of the bowl causes solid matter suspended in the feed liquid to move toward an inner surface of the bowl, and wherein the at least one wash nozzle comprises a first nozzle having a length that provides for contact between a distal end of the first nozzle and the solid matter at the inner surface of the bowl.

6. The method of claim 1, wherein the at least one nozzle comprises a plurality of nozzles spaced from each other around the cylindrical body.

7. The method of claim 1, wherein each of the at least one nozzles is positioned between adjacent scroll portions of the helical scroll flight.

8. The method of claim 1, wherein at least one of the nozzles comprises a first nozzle comprising a plate extending from an outer surface of the first nozzle.

9. The method of claim 8, wherein the plate comprises a distal end having a contoured surface.

10. The method of claim 1, wherein the liquid product is an oil product.

11. A scroll conveyor for making a liquid product, comprising:
a bowl comprising an inner area, a first portion adjacent to a first end of the bowl, a second portion adjacent to the first portion, and a discharge end opposite the first end; and
a scroll conveyor coaxially mounted within the bowl, the conveyor comprising a cylindrical body, a central opening extending through a length of the cylindrical body, a first end adjacent to the first end of the bowl, a second end spaced from the first end of the conveyor, a helical scroll flight extending from an outer surface of the cylindrical body, and at least one wash nozzle extending from the outer surface of the cylindrical body.

12. The scroll conveyor of claim 11, wherein the first portion of the bowl is cylindrical and the second portion of the bowl is tapered from the first portion of the bowl toward the second end of the bowl.

13. The scroll conveyor of claim 12, wherein each of the at least one wash nozzles extends from the cylindrical body of the conveyor along the first portion of the bowl.

14. The scroll conveyor of claim 11, wherein the at least one wash nozzle comprises a first nozzle having a length that provides for a space between the distal end of the first nozzle and an inner surface of the bowl.

15. The scroll conveyor of claim 11, wherein the at least one nozzle comprises a plurality of nozzles spaced from each other around the cylindrical body.

16. The scroll conveyor of claim 11, wherein each nozzle of the at least one nozzle is positioned between adjacent scroll portions of the helical scroll flight.

17. The scroll conveyor of claim 11, wherein the at least one nozzle is fluidly connected to a wash water feed supply that is separate from a feed liquid supply that is fluidly connected to the central opening of the scroll conveyor.

18. The scroll conveyor of claim 11, wherein at least one nozzle comprises:
an outer sleeve comprising an elongated opening having an inner surface, and at least one aperture; and
an inner feed tube positioned at least partially within the elongated opening of the outer sleeve, wherein the inner feed tube comprises a recessed portion that provides a fluid gap between an outer surface of the inner feed tube and the inner surface of the outer sleeve, and at least one aperture located at the fluid gap.

19. The scroll conveyor of claim 18, further comprising a plate extending at an angle from an outer surface of the outer sleeve.

20. The scroll conveyor of claim 19, wherein the plate comprises a distal end having a contoured surface.
